(19) United States
(12) Patent Application Publication
(10) Pub. No.: US 2026/0038393 A1
(43) Pub. Date: Feb. 5, 2026

(54) METHOD AND APPARATUS FOR PLACING A SIGN

(71) Applicant: David E. Daugherty, Massillon, OH (US)

(72) Inventor: David E. Daugherty, Massillon, OH (US)

(21) Appl. No.: 18/788,252

(22) Filed: Jul. 30, 2024

(51) Int. Cl. G09F 7/18; E02D 5/80

(52) U.S. Cl. CPC G09F 7/18; E02D 5/801; G09F 2007/1843; G09F 2007/1873

(57) ABSTRACT

A support mechanism for securing a sign having an anchor and a fastener with a threaded tip. The frame has a display secured thereto. The anchor engaged a frame of the sign. The fastener is rotatable about an axis that extends centrally through a shaft of the fastener. The anchor receives the fastener, and the fastener translates linearly in a vertical manner between a first and a second position in response about the axis of the fastener. The frame remains stationary as the fastener rotates. The fastener has an enlarged head adapted to engage a tool. The shaft extends downwardly from the enlarged head and the threaded tip extends downwardly from the shaft.

### TECHNICAL FIELD

The present disclosure relates generally to signs installed in the ground. More particularly, the present disclosure relates to a sign that includes anchors to help the sign maintain its position.

### BACKGROUND ART

Many companies, organizations, politicians, and individuals strive to find ways to market or advertise to large quantities of people. Throughout the years there have been many ways to advertise. One historic method of advertising has been lawn signs. Typically, the lawn signs are strategically placed in lawns, along streets, and anywhere else that may draw attention from a person.

Some of the lawn signs are placed for a short term such as during the election season while others may need to be in place for a longer amount of time. An example of time a sign may be desired to be placed for a longer amount of time is during a sale process of a home, the homeowner and agent desire for the sign to remain in place through the entirety of the home sale process. Another example for a longer term that a sign needs remain in a place is during the construction of a new building, the construction company or other companies involved with the building may desire to advertise their services while working on the project.

The lawn signs generally are placed in the open and are subject to environmental elements. Due to their environmental exposure, many signs are routinely removed from the desired location by high winds, soft ground, or many other factors. It is advantageous to have these signs remain in their desired places to maximize visibility and limit the labor involved with replacing the sign.

Many lawn signs have a frame with two vertical members that receive the sign and penetrate the ground to secure the frame to the ground. A second design is a frame that has two vertical members to receive the sign that meet at a spider stake. The spiker stake is then driven into the ground to secure the sign. Both designs have the disadvantage of not being secure during the duration of the need for the sign given the environmental exposure. One solution many have if the sign needs to be in place for a longer period of time, such as during a construction project, is to build a wooden frame and place the frame members in a deep hole. These wooden signs are also commonly secured with some amount of concrete. These wooden signs have a major disadvantage of causing excessive damage to the ground and requiring the user of the sign to fill the hole, possibly remove the concrete, and return the ground to the previous state.

### SUMMARY OF THE INVENTION

Accordingly, what is needed is an apparatus, device or article of manufacture that securely holds a sign in a position for a desired period of time that is easy to install yet should not require significant readjustment after installation. The present disclosure addresses this need by providing frame that holds a display panel, wherein the frame has mechanical components to easily and rapidly install the sign in a secure manner.

A support mechanism for securing a sign having an anchor and a fastener with a threaded tip. The frame has a display secured thereto. The anchor engaged a frame of the sign. The fastener is rotatable about an axis that extends centrally through a shaft of the fastener. The anchor receives the fastener, and the fastener translates linearly in a vertical manner between a first and a second position in response about the axis of the fastener. The frame remains stationary as the fastener rotates. The fastener has an enlarged head adapted to engage a tool. The shaft extends downwardly from the enlarged head and the threaded tip extends downwardly from the shaft.

In one aspect, an exemplary embodiment of the present disclosure may provide a support mechanism for securing a sign comprising an anchor operably engaged with a frame, a fastener having a threaded tip, wherein the fastener is rotatable about an axis that extends centrally through a shaft of the fastener, and wherein the anchor receives the fastener and the fastener linearly translates in a vertical manner between a first position and a second position in response to rotation about the axis of the fastener, wherein the frame remains stationary as the fastener rotates.

In another aspect, an exemplary embodiment of the present disclosure may provide where the frame defines an internal space between two vertical planes, and wherein the anchor is located outside of the internal space. In another aspect, an exemplary embodiment of the present disclosure may provide where the fastener comprises an enlarged head adapted to engage a tool, wherein the shaft extends downward from the enlarged head, and wherein the threaded tip extends downward from the shaft. In another aspect, an exemplary embodiment of the present disclosure may provide where the anchor comprises a tube configured to receive the fastener, and a connector that connects the tube with the frame, wherein the connector has a width dimension that positions the tube outside of the internal space and apart from the frame such that a gap is defined between and outer surface of the tube and an outer surface of the frame. In another aspect, an exemplary embodiment of the present disclosure may provide where the anchor comprises a first connector and a second connector fixedly connected with an outer surface of the frame, and where the first and second connectors are configured to freely receive the fastener. In another aspect, an exemplary embodiment of the present disclosure may provide where the anchor comprises a support extending outwardly from the frame, a bore defined by and extending through the support, and where the bore is configured to receive the fastener therethrough. In another aspect, an exemplary embodiment of the present disclosure may provide where the anchor comprises a receiver configured to receive and hold at least a portion of the frame, a set of supports extending outwardly from the receiver, a set of bores extending through each one of the set of supports, a set of fasteners, and wherein each one of the set of bores are configured to receive one of the set of fasteners.

In one aspect, an exemplary embodiment of the present disclosure may provide a sign comprising a frame and a display secured thereto, a fastener operably engaged with the frame, wherein the fastener is rotatable about an axis that extends centrally through a shaft of the fastener, a threaded tip integral with the fastener, said threaded tip adapted to penetrate a ground, and where the threaded tip of the fastener secures the frame to the ground, and where the fastener linearly translates in a vertical manner between a first position and a second position in response to rotation about an axis of the fastener, where the frame remains stationary as the fastener rotates.

In another aspect, an exemplary embodiment of the present disclosure may provide an anchor configured to receive the fastener where the anchor is engaged with the frame. In another aspect, and exemplary embodiment of the present disclosure may provide where the frame comprises a first member and a second member spaced a distance apart from one another, a third member and a fourth member extending between and connected to first and second members, an attachment extending between first and second members and configured to secure to display to the frame, a first tube engaged with the first member via a first connector, a second tube engaged with the second member via a second connector, and where the first and second tubes are configured to receive the fastener. In another aspect, an exemplary embodiment of the present disclosure may provide where wherein the frame comprises a first member and a second member spaced a distance apart from one another, a third member and a fourth member extending between and connected to first and second members, an attachment extending between first and second members and configured to secure to display to the frame, a first connector and a second connector extending outwardly from both the first and second members, and where the first and second connectors on both the first and second members are configured to receive the fastener. In another aspect, an exemplary embodiment of the present disclosure may provide where the fame comprises a first member and a second member spaced a distance apart from one another, a pair of tines extending outwardly from the first and second members and configured to secure the display to the frame, a first support extending outwardly from the first member and defining a first bore therethrough, a second support extending outwardly from the second member and defining a second bore, and where the first bore and the second bore are configured to receive the fastener. In another aspect, an exemplary embodiment of the present disclosure may provide where the frame comprises a post configured to secure the display via a securement mechanism, a receiver configured to receive and hold the post, a set of supports extending outwardly from the receiver, a set of bores extending through each of the set of supports, where each of the set of bores is configured to receive the fastener. In another aspect, an exemplary embodiment of the present disclosure may provide the fastener comprises an enlarged head adapted to engage a tool, a shaft extending outwardly from the enlarged head, and where the threaded tip extends outwardly from the shaft.

In one aspect, an exemplary embodiment of the present disclosure may provide a method of installing a sign comprising connecting a display with a frame, engaging a fastener with the frame, where the fastener has a threaded tip, engaging the threaded tip with the ground, and rotating the fastener to penetrate the ground with the threaded tip while the frame remains stationary to thereby secure the frame to the ground.

In another aspect, and exemplary embodiment of the present disclosure may provide the method further comprising linearly translating the fastener along a vertical path of travel from a first position to a second position in response to rotating the fastener, wherein the vertical path of travel is located outside of a vertical plane defined by a vertical member of the frame. In another aspect, and exemplary embodiment of the present disclosure may provide the method further comprising engaging a tool with an enlarged head of the fastener, where a shaft extends downward from the enlarged head and the threaded tip is integrally formed with the shaft, powering the tool, and penetrating the ground with the threaded tip via the tool and thereby securing the frame to the ground. In another aspect, and exemplary embodiment of the present disclosure may provide the method further comprising securing the display to first and second members on the frame via an attachment. In another aspect, and exemplary embodiment of the present disclosure may provide the method further comprising engaging a tube with both the first and second members of the frame, and placing the shaft of the fastener within each of the tubes. In another aspect, and exemplary embodiment of the present disclosure may provide the method further comprising engaging a first connector with the first member of the frame, engaging a second with the second member of the frame, and placing a shaft of the fastener within each of the first and second connectors. In another aspect, and exemplary embodiment of the present disclosure may provide the method further comprising extending a first support outwardly from the first member of the frame, extending a second support outwardly from the second member of the frame, extending a bore through each of the first and second supports, and receiving the shaft of the fastener within each of the first and second bores of the first and second supports. In another aspect, and exemplary embodiment of the present disclosure may provide the method further comprising providing a post on the frame, engaging the post with a receiver, extending a support outwardly from the receiver, extending a set of bores through the support, and receiving a set of fasteners within the set of bores.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is front, top, left perspective view of a first embodiment of a sign in accordance with the present disclosure.

FIG. 2 is an enlarged front, top, left perspective view of the region labeled “FIG. 2” in FIG. 1 of the first embodiment of the sign.

FIG. 3 is an enlarged partial front elevation view of the first embodiment of the sign shown in FIG. 1.

FIG. 4 is an enlarged partial elevational cross section view of the first embodiment of the sign taken along line 4-4 in FIG. 2.

FIG. 5A is a partial front elevation operational view of the first embodiment of the sign shown in FIG. 1 being secured into a ground.

FIG. 5B is a partial front operational view of the first embodiment of the sign shown in FIG. 5 shown secured into the ground.

FIG. 6 is a front, top, left perspective view of a second embodiment of a sign in accordance with an aspect of the present disclosure.

FIG. 7 is an exploded front, top, left perspective view of the region labeled “FIG. 7” in FIG. 6 of the second embodiment of the sign.

FIG. 8 is an exploded front, top, left perspective view of the region labeled “FIG. 8” in FIG. 6 of the second embodiment of the sign.

FIG. 9 is a front elevation operational view of the second embodiment of the sign shown in FIG. 6 shown secured into the ground.

FIG. 10 is a front, top, left perspective view of a third embodiment of a sign in accordance with an aspect of the present disclosure.

FIG. 11 is a cross section view of the third embodiment of the sign taken along line 11-11 in FIG. 10.

FIG. 12 is a front, top, left perspective view of a fourth embodiment of a sign in accordance with an aspect of the present disclosure.

FIG. 13 is a cross section view of the fourth embodiment of the sign taken along line 13-13 in FIG. 12.

Similar numbers refer to similar parts throughout the drawings.

### DETAILED DESCRIPTION

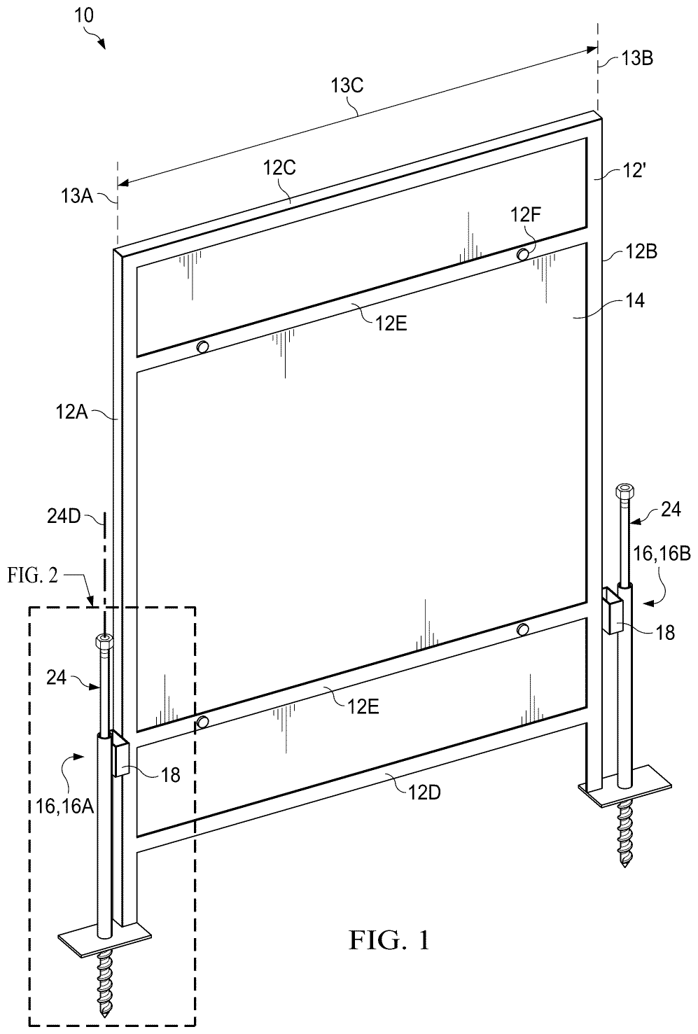

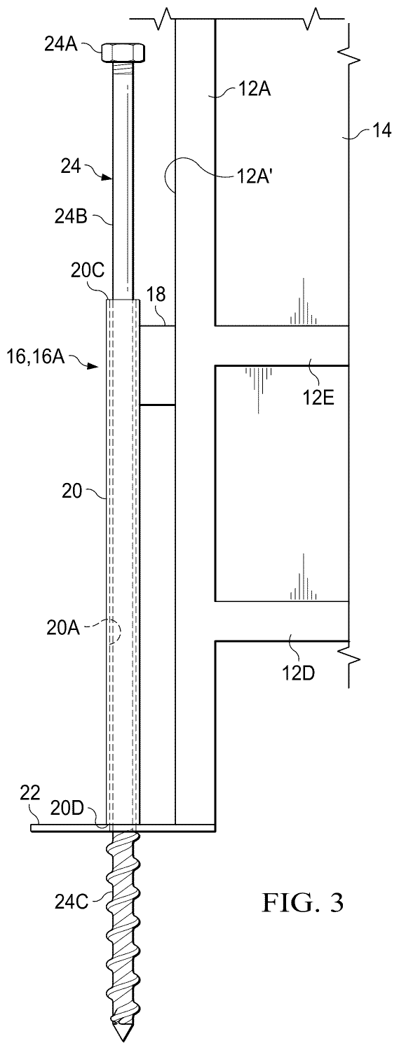

Referring to FIGS.1-5B there is shown a first embodiment of a sign in accordance with the present disclosure, generally indicated at 10. Sign 10 generally comprises a frame 12, at least one display 14 and at least one anchor 16.

Referring to FIG. 1, in one embodiment, frame 12 is generally square in shape and comprises a first member 12A and a second member 12B opposite and spaced apart from one another. The first member 12A and the second member 12B may be oriented such that a maximum dimension or length is oriented vertically. Frame 12 further comprises a third member 12C and a fourth member 12D opposite and spaced apart from one another. The third member 12C and the fourth member 12D may be oriented perpendicular to the first member 12A and the second member 12B such that their maximum dimension or length is oriented horizontally. In one particular embodiment, each of the first member 12A, second member 12B, third member 12C and fourth member 12D comprises a rolled metal component which is welded or otherwise secured at each end to an end of an adjacent member to form an integral component or integral frame 12. The configuration of each member 12A, 12B, 12C, 12D may vary depending on the particular application of sign 10.

It will be understood that the overall size of first member 12A, second member 12B, third member 12C and fourth member 12D will vary based on the overall size of sign 10. In the embodiment illustrated herein first member 12A and second member 12B are of the same size and third member 12C and fourth member 12D are of the same size. It will also be understood t hat the members 12A-12D need not form a square or rectangular configuration. Additional members can be utilized to form any other configuration that retains the display 14. For example, additional members can be utilized to form a pentagonal, hexagonal, heptagonal, octagonal or other symmetric or asymmetric configuration to retain display 14. In another example, fewer members can be utilized to form a triangular configuration to retain display 14.

Frame 12 further comprises an attachment 12E extending between and connecting to first and second members 12A, 12B. First member 12A, second member 12B, third member 12C, fourth member 12D and attachment 12E are configured to receive and secure display 14 to frame 12. Display 14 is secured to attachment 12E via a bolt 12F. However, it is to be understood that bolt 12F is just one type of connector utilized to attach the display 14 to the frame 12. Other connectors, either mechanical (e.g., zip ties), chemical (e.g., adhesives), or non-mechanical and non-chemical connections can be utilized.

In one specific embodiment, attachment 12E may extend between and connect to third and fourth members 12C, 12D.

It will be understood that frame 12 as illustrated herein is generally rectangular in shape, frame may alternatively be of any shape appropriate to engage the display. It will be understood that frame 12 as illustrated herein comprises the display 14 extending from first and second member and third and fourth member, display 14 may alternatively be of any size or shape to be received within frame 12 and secured via the attachment 12E. It will also be understood that frame 12 as illustrated herein comprises display 14 being secured to the frame via a first and a second attachment, may include any number of attachments suitable to secure the display to the frame.

Frame 12 and its constituent frame members 12A-12E is generally made from a metal such as aluminum or steel. It will be understood that while frame 12 is generally metal, frame may be made of any other material suitable to receive and hold display.

Display 14 is generally made of a plastic or vinyl material and is printed to show the desired items. It will be understood that display 14 may be of any material suitable to display the desired items and to be received and held by frame. Display 14 is of a size and shape to be complementary to the size and shape of the opening of the frame 12. Further, while the display 14 is shown in FIG. 1 is a singular display, it is entirely possible to have two displays arrange back-to-back so that each of the displays faces outward from the sign 10.

Referring to FIG. 1, sign 10 comprises a first anchor 16A (also referred to herein as anchor 16) and a second anchor 16B. First anchor 16A is operably engaged with first member 12A. Second anchor 16B is operatively engaged with second member 12B. First anchor 16A and second anchor 16B are identical to one another except for orientation, namely the first anchor 16A is on the first side of the sign and the second anchor 16B is on the second side of the sign 10. It will be understood that the following description of anchor 16 will apply equally to first anchor 16A and second anchor 16B. It also will be understood that although sign 10 illustrated herein comprises first anchor 16A and second anchor 16B, sign 10 may alternatively have any number of anchors.

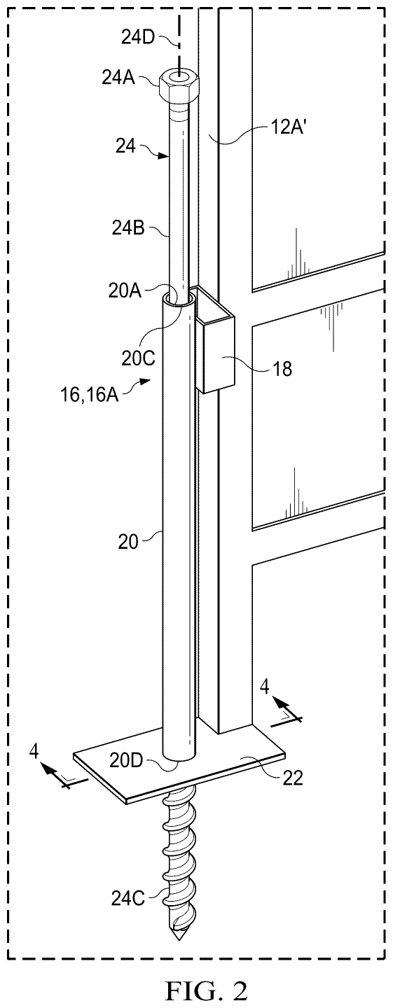

Referring to FIGS. 2-4, anchor 16 generally is adapted to semi-permanently secure frame 12 and thereby sign 10 to a ground surface. Anchor 16 comprises a connector 18 operably engaged or fixedly connected with first member 12A to connect anchor 16 to frame 12. Connector 18 is operably engaged or fixedly connected to an outer surface 12A′ of first member 12A. Anchor 16 further comprises a tube 20 defining an inner bore 20A. The tube 20 is engaged with frame 12 via connector 18. In one embodiment, the connector 18 is a cuboid-shaped member having a width dimension that spaced the tube 20 a distance from the first member 12A such that a slight gap or space “L” is defined between the outer surface 12A′ of the first member 12A and an outer surface 20B of the tube 20. As such, the connector 18 may also be considered to be a spacer. In one exemplary embodiment, it may advantageous to space the tube 20 from the frame member 12A because, as well be described below, a fastener 24 having an enlarged head 24A will be used to connect the sign 10 to the ground, and the enlarged head 24A will need sufficient clearance or space to rotate. If the tube 20 is too close to the frame member 12A, then it could be difficult to rotate the enlarged head as it may contact the frame member 12A and not fully rotate about a vertical axis.

In one particular embodiment, the outer surface 12A′ of the first member 12A lies along a first vertical plane 13A. The outer surface of the second member 12B lies along a second vertical plane 13B. An internal space 13C is defined between the first vertical plane 13A and the second vertical plane 13B. In one embodiment, the cross members 12C, 12D and 12E extend horizontally or laterally within the internal space 13C between the between the first vertical plane 13A and the second vertical plane 13B. Other components are located externally or outside of the internal space 13C. For example, the first anchor 16A is offset from the first vertical plane 13A such that it is positioned distally from the first vertical plane 13A to be located outside of (i.e., not within) the internal space 13C. Similarly, the second anchor 16B is offset from the second vertical plane 13B such that it is positioned distally from the second vertical plane 13B to be located outside of (i.e., not within) the internal space 13C.

The length of the tube 20, and therefor the inner bore 20A of the tube 20 is oriented in the vertical direction and parallel to the first member 12A. The tube 20 has a length that extends from a first end 20C to a second end 20D. In one particular embodiment, the first end 20C of the tube 20 is positioned above the second end 20D of the tube 20, wherein the first end 20C terminates at a location that is approximately equal with one of the frame members that extend horizontally between the first and second members 12A, 12B. In the shown embodiment, the first end or upper end 20C of the tube 20 terminates at approximately the same height as the lower attachment member 12E.

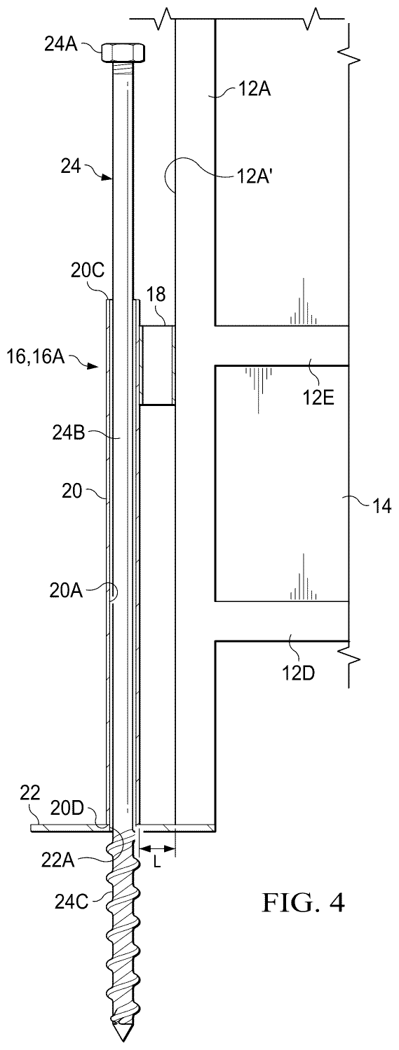

Anchor 16 further comprises a plate 22 engaged with and connecting a bottom end of either the first or second member 12A, 12B to a bottom or second end 20D of tube 20. Plate 22 defines a hole 22A (FIG. 4) extending through plate 22 and configured to allow fastener 24 to pass through plate 22. The inner bore 20A of the tube 20 is vertically aligned with the hole 22A defined in plate 22. Further, while plate 22 is depicted as rectangular in configuration, any shape is possible.

In one specific embodiment, connector 18 may be welded or otherwise secured to an outer surface 12A of the first member. Tube 20 may be welded or otherwise secured to an outer plate of connector 18. Plate 22 may be welded or otherwise secured to bottom end of either first or second member and bottom end of tube 20.

In another specific embodiment, tube 20 may be welded or otherwise secured directly to the outer surface of first member without the use of connector 10. However, as mentioned previously, if this configuration is utilized, the dimensions of the fastener 24 and its enlarged head 24A should be able to be rotated to drive the fastener into the ground in order to secure the sign 10 to the same.

Fastener 24 includes an enlarged head 24A adapted to engage a drill or a tool, which will be described in more detail below regarding a method of installing the sign 10. As best seen in FIG. 4, fastener 24 further comprises a shaft 24B extending outwardly from head 24A and configured to be received within the bore 20A of tube 20 of anchor 16. In one particularly embodiment, the fastener 24 is freely coupled to the tube 20 of anchor 16 such that the rotation of the fastener 24 within tube 20 is boundless. The vertical path of travel of the fastener 24 may be linear bounded between a maximum first position and a minimum second position. Fastener 24 further comprises a threaded tip 24C extending outwardly and integral with shaft 24B. The threaded tip 24C can have enlarged helical or spirally wound flights that are configured to engage the ground as the fastener rotates about a longitudinal axis 24D that extends centrally through shaft 24B. Head 24A, shaft 24B, and threaded tip 24C are configured to secure anchor 16 and thereby the frame 12 to the ground, which will be described in more detail below regarding a method of installing the sign.

It will be understood that sign 10 may have a first fastener engaged with first anchor 16A and a second fastener engaged with second anchor 16B. In one embodiment, the helical flights or thread on the fastener 24 of the first anchor 16A and the helical flights or thread on the fastener 24 of the second anchor 16B may wind or spiral in the same direction. This configuration would make the drilling process simple and not require any tooling changes as the operator installs the sign 10. However, in another particular embodiment, the helical flights or thread on the fastener 24 of the first anchor 16A and the helical flights or thread on the fastener 24 of the second anchor 16B may wind or spiral in the different direction (e.g., one of the two fasteners 24 is reverse threaded). This configuration would be advantages to create offsetting installation orientations to resist external forces, such as wind, that impact the sign.

In one specific embodiment, an interior surface of the tube may include threading. The shaft of the fastener may also include threading which is complementary to the treading on the interior surface of the tube.

Having now described sign 10, a method of installing sign 10 will now be described in greater detail.

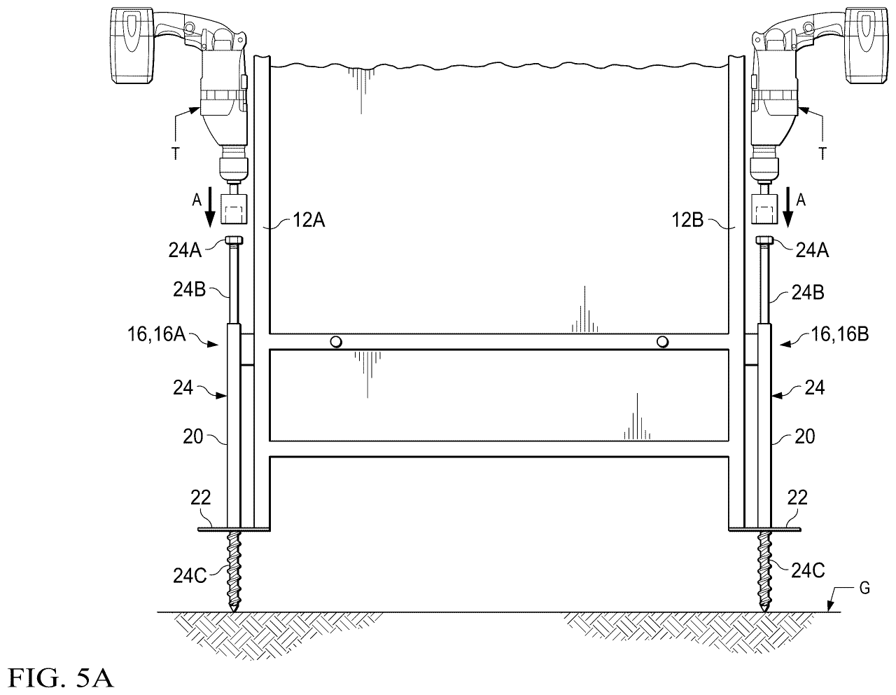

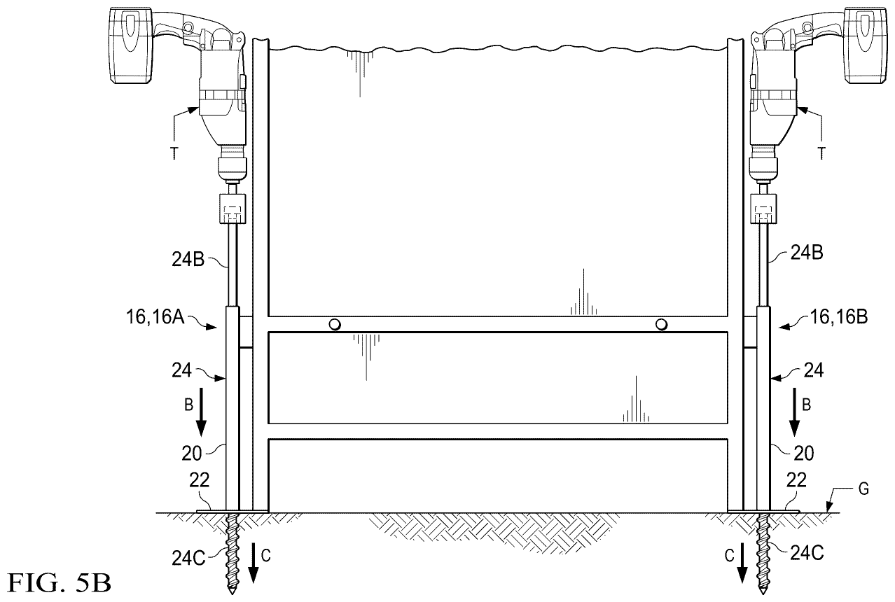

Referring to FIG. 5A, a user provides the frame 12 with display 14 secured thereto. The user engages anchor 16 with first or second member 12A, 12B. The user then places fastener 24 within tube 20 and through the hole 22A in plate 22 of anchor 16. A user places the threaded tip 24C of the fastener in a desired location along a ground “G”. The user then lowers a tool or a drill “T” onto head 24A of fastener 24 in the direction of arrows “A”.

Referring now to FIG. 5B, the user then secures sign 10 by engaging the tool “T” to lower anchor 16 in the direction of arrows “B” by penetrating the ground “G” with threaded tip 24C. Particularly, the tool drives the fastener 24 in a rotational action to effectuate linear translation of the faster from the first position (i.e., its maximum height relative to ground “G”) to the second position (i.e., its minimum height relative to ground “G”). While the fastener is rotating, as being driven by the tool “T”, the frame 12 remains stationary and does not rotate or otherwise significantly move. The threaded tip 24C penetrates the ground “G” in the direction of arrows “C”. Once sign 10 is secured, plate 22 of anchor 16 is directly atop a top surface of the ground “G”. After sign 10 is secured, at least a portion of the shaft 24B of the fastener 24 will extend outwardly from tube 20. Also, after sign 10 is secured the user may remove the tool “T” from the head 24A.

Stated otherwise, the fastener 24 may move along a linear path of travel between a first position and a second position. In one particular embodiment, the linear path of travel of the fastener occurs in a directly vertical movement. In the shown embodiment, the first position is depicted as the raised position at which the enlarged head 24A is at its maximum height relative to ground. The second position is depicted as the lowered position at which the enlarged head 24A is at its minimum height relative to ground. The shown embodiment depicts that the linear movement between the first position and the second position is accomplished by a rotational movement about the axis of shaft 24B that effectuates linear translation of the fastener due to threads 24C engaging the ground “G”. In this embodiment, the rotation-to-linear translation of the fastener 13 occurs outside of the internal space 13C defined between vertical planes 13A, 13B. During the rotation-to-linear translation of the fastener, the frame 12 remains in place and is relatively stationary due to the rotational action of the fastener occurring within the bore of the tube 20 through which the fastener 24 extends.

Once sign 10 is no longer needed and needs to be removed, the user reengages tool “T” with head 24A of fastener 24. The user engages tool “T” to remove the threaded tip 24C from the ground “D” in a direction opposite from arrows “C” which will lift anchor 16 and thereby sign 10 in a direction opposite from arrows “B”.

Although this foregoing embodiment is shown being installed with the sue of the tool “T”, another tool could be substituted for the drill. For example, instead of the drill a user could use a wrench to engage the head 24A of fastener 24 and use the wrench to rotate the fastener 24 to connect the sign to ground “G.”

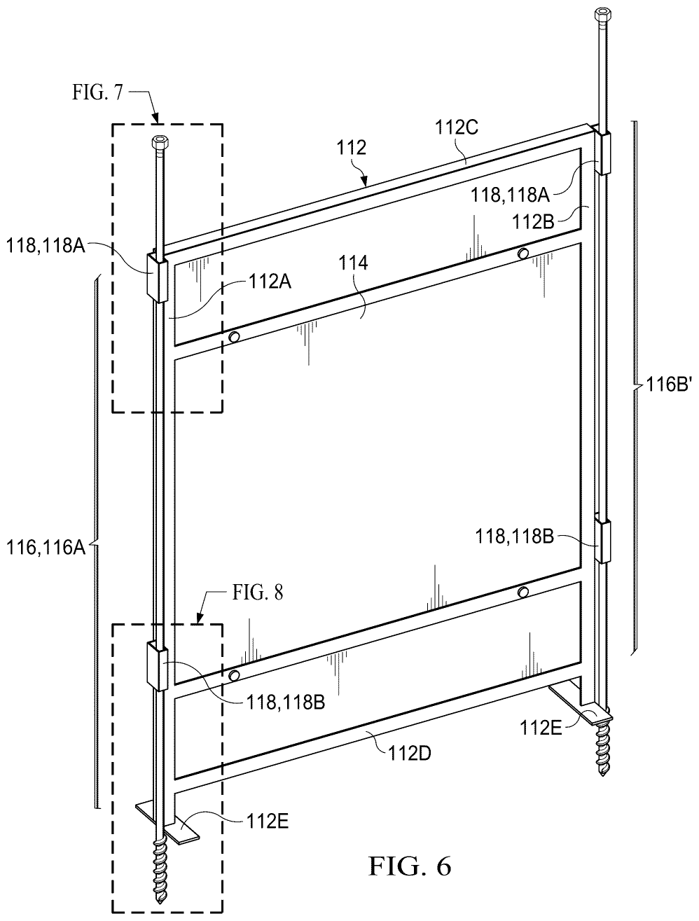

Referring to FIGS. 6-9, there is shown a second embodiment of a sign in accordance with an aspect of the present disclosure, generally indicated at 110. Sign 110 comprises a frame 112, a display 114 and an anchor 116. Display 114 is substantially identical to display 14 and therefore will not be described in much detail hereafter.

Referring to FIG.6, frame 112 is substantially identical to frame 112 except for the particular features described below. Frame 112 comprises a first member 112A and a second member 112B opposite and spaced apart from one another. Frame 112 comprises a third member 112C and a fourth member 112D opposite and spaced apart from one another.

First member 112A and second member 112B each include a platform 112E engaged with each of the first and second members 112A, 112B. Platform 112E are each substantially perpendicular to the respective first and second members 112A, 112B.

Sign 110 comprises a first anchor 116A (also referred to herein as anchor 116) and a second anchor 116B. First anchor 116A is operably engaged with a first member 112A. Second anchor 116B is operatively engaged with second member 112B. First anchor 116A and second anchor 116B are identical to one another except for their orientation on opposite sides of frame 112. It will be understood that the following description of anchor 116 will apply equally to first anchor 116A and second anchor 116B.

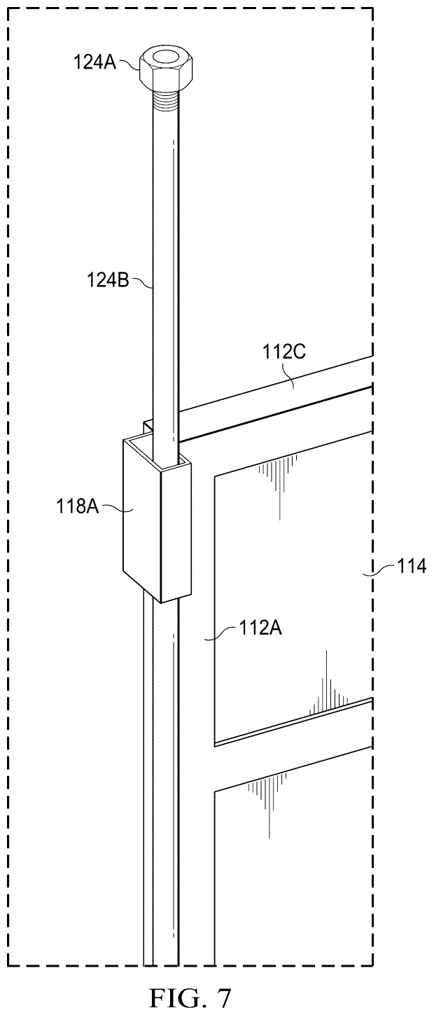

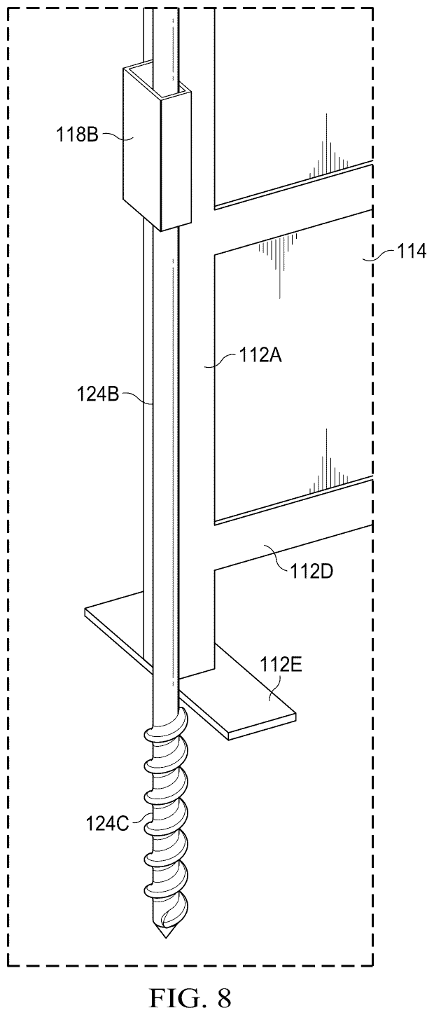

Referring to FIGS. 7 and 8, anchor 116 comprises a first connector 118A and a second connector 118B operably engaged with first member 112A. Specifically, first and second connectors 118A, 118B are operably engaged with an outer surface of second member 112A of frame 112. First connector 118A is disposed near a top of frame 112. Second connector 118B is disposed closer to a bottom of frame 112. First and second connectors 118A, 118B are of a shape and size to receive at least a portion fastener 124.

In one specific embodiment, a top surface of first connector 118A is substantially aligned with a top surface of third member 112C of frame 112.

Fastner 124 is substantially identical in structure to fastener 24 except for the size. Fastener 124 comprises an enlarged head 124A, a shaft 124B and a threaded tip 124C. Shaft 124B extends between first connector 118A and second connector 118B. First and second connector 118A, 118B are configured to receive at least a portion of shaft 124B of fastener 124. Head 124A, shaft 124B and threaded tip 124C will be described in more detail below regarding a method of installing the sign.

Having now described sign 110, a method of installing sign 110 will now be described in greater detail.

The user provides the frame 112 with display 114 secured thereto. The user engages anchor 116 with first are second member 112A, 112B. The user then places fastener 124 within first and second connectors 118A, 118B. A user places the threaded tip 124C of the fastener in a desired location along the ground “G”. The user then lowers a tool “T” onto head 124A of fastener 124.

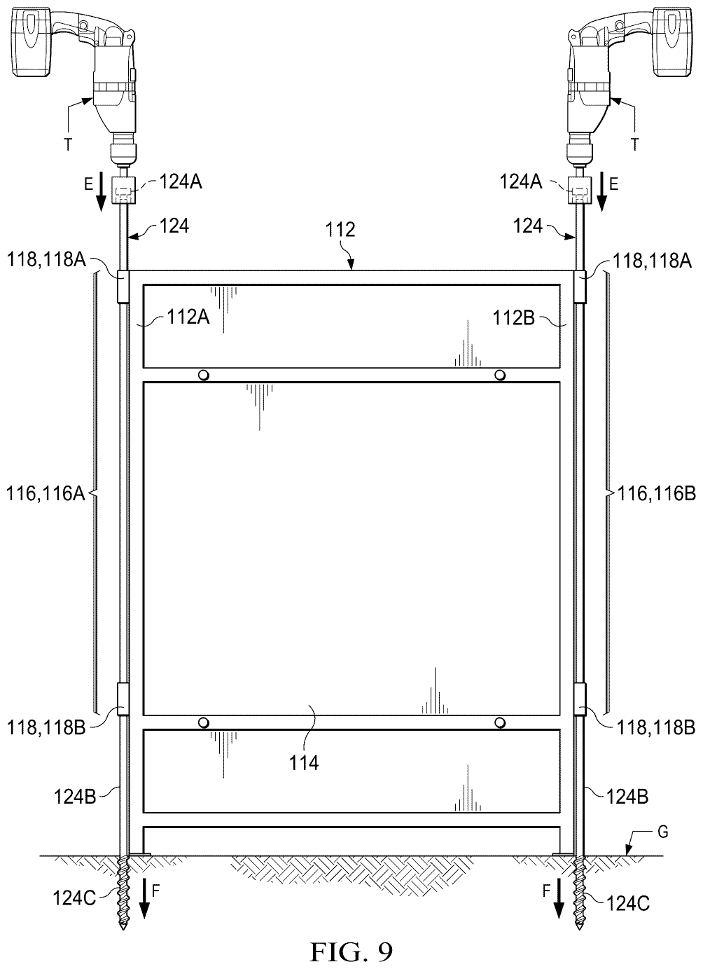

Referring now to FIG. 9, the user then secures sign 110 by engaging the tool “T” to lower fastener 124 in the direction of arrows “E” by penetrating the ground “G” with threaded tip 124C. The threaded tip 124C penetrates the ground “G” in the direction of arrows “F”. After sign 110 is secured, the entirety of threaded tip 124C is within the ground “G”. Also, after sign 110 is secured the user may remove the tool “T” from the head 124A.

Once sign 110 is no longer needed and needs to be removed, the user reengages tool “T” with head 124A of fastener 124. The user engages tool “T” to remove the threaded tip 24C from the ground “D” in a direction opposite from arrows “F” which will lift anchor 16 and thereby sign 10 in a direction opposite from arrows “E”.

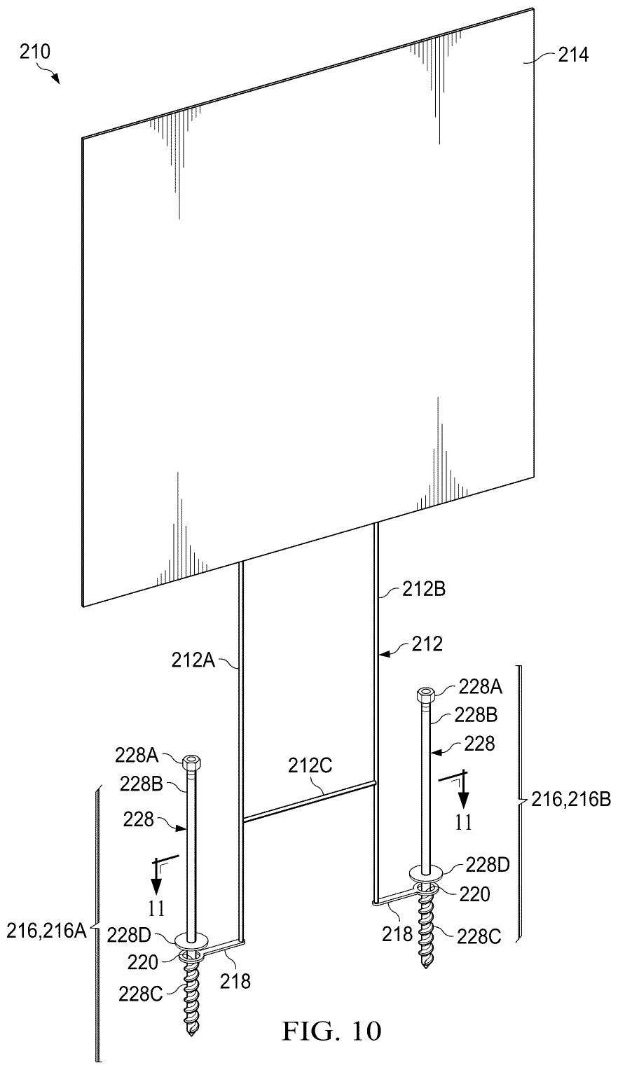

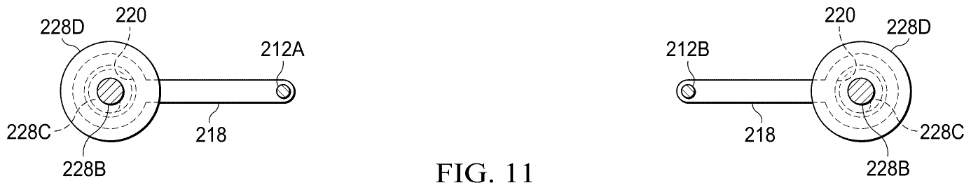

Referring to FIGS. 10 and 11, there is shown a third embodiment of a sign in accordance with an aspect of the present disclosure, generally indicated at 210. Sign 210 comprises a frame 212, a display 214 and an anchor 216.

Frame 212 is generally the same shape and style as a step stakes. Frame 212 comprises a first member 212A and a second member 212B opposite and spaced a distance apart from one another. Frame 212 further comprises a third member or a support member 212C extending between and connecting first and second member 212A, 212B.

Although not pictured here, frame 212 comprises a bar extending between first and second members 212A, 212B and a pair of tines extending outwardly from the bar configured to receive and hold a portion of the display 214.

Frame 212 is generally made from a metal wire such as stainless steel wire. It will be understood that while frame 212 is generally metal, frame may be made of any other material suitable to receive and hold display.

Display 214 is generally made of corrugated plastic and is printed or manufactured to show the desired items. It will be understood that display 214 may alternatively be made of any suitable material to show the desired items and to be received and held by frame 212.

Sign 210 comprises a first anchor 216A (also referred to herein as anchor 216) and a second anchor 216B. First anchor 216A is operably engaged with a first member 212A. Second anchor 216B is operatively engaged with second member 212B. First anchor 216A and second anchor 216B are identical to one another except for their connection with frame 212 on opposite sides thereof. It will be understood that the following description of anchor 216 will apply equally to first anchor 216A and second anchor 216B.

Referring to FIGS. 10 and 11, anchor 216 comprises a support 218 engaged with and extending outwardly from first member 212A. Support 218 is generally a flat plate extending outwardly from a bottom end of the first member 212A. Support 218 defines a bore 220 extending through the support 218 and configured to receive a fastener 228.

It will be understood that sign 210 may comprise a first support on first anchor 216A and engaged with first member 212A. First support may define a first bore extending therethrough. It will also be understood that sign 210 may comprise a second support on second anchor 216B and engaged with second member 212B. Second support may define a second bore extending therethrough.

In one specific embodiment, support may be integral with first member or second member of frame.

Fastner 224 comprises a head 224A adapted to engage a drill, a shaft 224B extending outwardly from head 224A. Fastener 224 further comprises a threaded tip 224C extending outwardly from shaft 224B and adapted to engage a ground surface to secure sign 210 to ground. Fastener 224 further includes a washer 224D integral with a portion of shaft 224B. Head 224A, shaft 224B, threaded tip 224C, and washer 224D will be described in more detail below regarding a method of installing the sign.

Having now described sign 210, a method of installing sign 210 will now be described in greater detail.

The user provides the frame 212 with display 214 secured thereto. The user engages anchor 216 with first or second member 212A, 212B. The user then places fastener 224 within the bore 220 of each the first and second anchors 216A, 216B. A user places the threaded tip 224C of the fastener in a desired location along the ground. The user then lowers the drill onto head 224A of fastener 224.

The user then secures sign 210 by engaging the drill to lower fastener 124 by penetrating the ground with threaded tip 224C. After sign 210 is secured, the entirety of threaded tip 224C is within the ground and a lower surface of washer 224D is directly atop an upper surface of support 218. Also, after sign 210 is secured the user may remove the drill from the head 224A.

Once sign 210 is no longer needed and needs to be removed, the user reengages the drill with head 224A of fastener 224. The user engages drill to remove the threaded tip 224C from the ground which will lift anchor 216 and thereby sign 210 out of the ground.

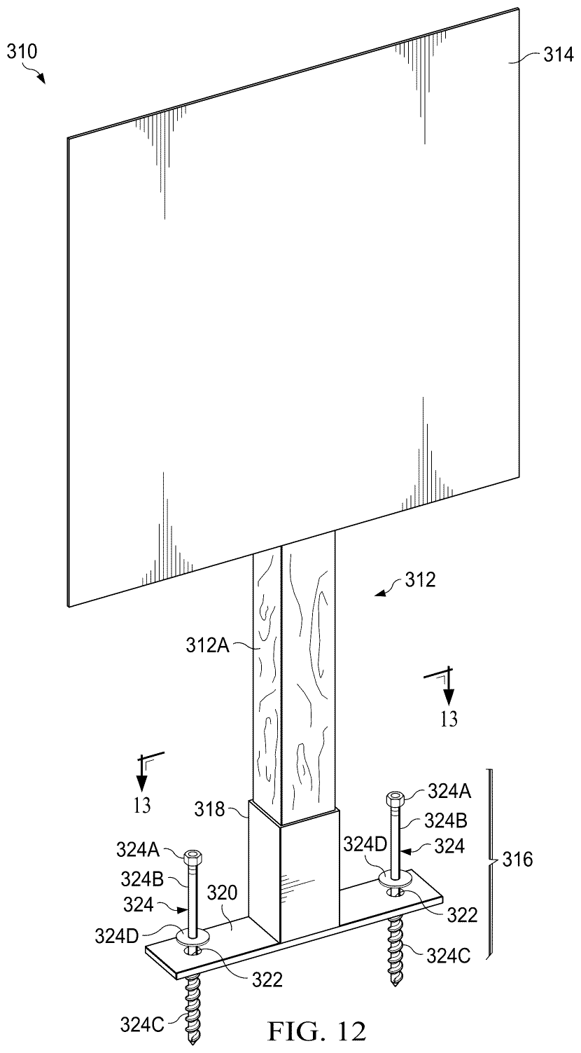

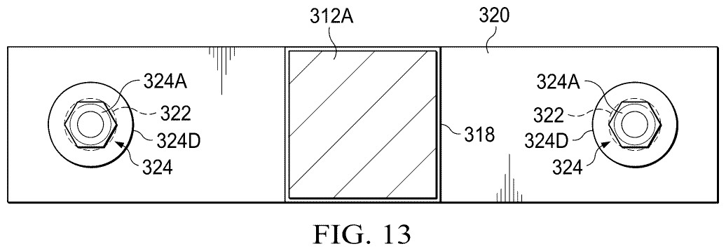

Referring to FIGS. 12 and 13, there is shown a fourth embodiment of a sign in accordance with an aspect of the present disclosure, generally indicated at 310. Sign 310 comprises a frame 312, a display 314 and an anchor 316.

Referring to FIG. 12, frame 312 comprises a member or a post 312A. It will be understood that frame 312 as illustrated herein comprises a singular post, frame may alternatively comprise any number of posts.

Frame 312 is generally made from wood. It will be understood that while frame 312 is generally wood, frame may be made of any other material suitable to receive and hold display.

Display 314 generally made of plastic or wood and is printed or manufactured to show the desired items. It will be understood that display 314 may alternatively be made of any suitable material to show the desired items and to be received and held by frame 312.

Although not pictured herein, display 314 is secured to post 312A of frame 312 via a securement member, which may comprise a bracket and a screw.

Referring now to FIGS. 12 and 13, anchor 316 includes a receiver 318 configured to receive and hold post 312A of frame 312. Anchor 316 further includes a support 320 extending outwardly from receiver 318. Support 320 is adapted to engage and sit on the ground. Support 320 further defines a set of bores 322 extending though support 320 and configured to receive a set of fasteners 324. Set of fasteners 324 comprises a head 324A, a shaft 324B, a threaded tip 324C and a washer 324D and is substantially identical to fastener 224 and therefore will not be described in much detail hereafter except for below regarding to a method of installing the sign.

Having now described sign 310, a method of installing sign 310 will now be described in greater detail.

The user provides the frame 312 with display 314 secured thereto. The user places the post or the member 312A within the receiver 318 of the anchor 316. The user then places the set of fasteners 324 within the set of bores 322 extending through the support 320. A user places the threaded tip 324C of the fastener 324 in a desired location along the ground. The user then lowers the drill onto head 324A of fastener 324.

The user then secures sign 310 by engaging the drill to lower fastener 324 by penetrating the ground with threaded tip 324C. After sign 310 is secured, the entirety of threaded tip 324C is within the ground and a lower surface of washer 324D is directly atop an upper surface of support 320. Also, after sign 310 is secured the user may remove the drill from the head 324A.

Once sign 310 is no longer needed and needs to be removed, the user reengages the drill with head 324A of fastener 324. The user engages drill to remove the threaded tip 324C from the ground which will lift anchor 316 and thereby sign 310 out of the ground.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the frame being rectangular, the frame 12 can be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A support mechanism for securing a sign comprising:
an anchor operably engaged with a frame;
a fastener having a threaded tip, wherein the fastener is rotatable about an axis that extends centrally through a shaft of the fastener; and
wherein the anchor receives the fastener and the fastener linearly translates in a vertical manner between a first position and a second position in response to rotation about the axis of the fastener, wherein the frame remains stationary as the fastener rotates.

2. The support mechanism in accordance with claim 1, wherein the frame defines an internal space between two vertical planes, and wherein the anchor is located outside of the internal space.

3. The support mechanism in accordance with claim 1, wherein the fastener comprises:
an enlarged head adapted to engage a tool;
wherein the shaft extends downward from the enlarged head; and
wherein the threaded tip extends downward from the shaft.

4. The support mechanism in accordance with claim 1, wherein the anchor comprises:
a tube configured to receive the fastener; and
a connector that connects the tube with the frame, wherein the connector has a width dimension that positions the tube outside of the internal space and apart from the frame such that a gap is defined between and outer surface of the tube and an outer surface of the frame.

5. The support mechanism in accordance with claim 1, wherein the anchor comprises:
a first connector and a second connector fixedly connected with an outer surface of the frame; and
wherein the first and second connectors are configured to freely receive the fastener.

6. The support mechanism in accordance with claim 1, wherein the anchor comprises:
a support extending outwardly from the frame;
a bore defined by and extending through the support; and
wherein the bore is configured to receive the fastener therethrough.

7. The support mechanism in accordance with claim 1, wherein the anchor comprises:
a receiver configured to receive and hold at least a portion of the frame;
a set of supports extending outwardly from the receiver;
a set of bores extending through each one of the set of supports;
a set of fasteners; and
wherein each one of the set of bores are configured to receive one of the set of fasteners.

8. A sign comprising:
a frame and a display secured thereto;
a fastener operably engaged with the frame, wherein the fastener is rotatable about an axis that extends centrally through a shaft of the fastener;
a threaded tip integral with the fastener, said threaded tip adapted to penetrate a ground; and
wherein the threaded tip of the fastener secures the frame to the ground, and wherein the fastener linearly translates in a vertical manner between a first position and a second position in response to rotation about an axis of the fastener, wherein the frame remains stationary as the fastener rotates.

9. The sign in accordance with claim 8, further comprising:
an anchor configured to receive the fastener; and
wherein the anchor is engaged with the frame.

10. The sign in accordance with claim 8, wherein the frame comprises:
a first member and a second member spaced a distance apart from one another;
a third member and a fourth member extending between and connected to first and second members;
an attachment extending between first and second members and configured to secure to display to the frame;
a first tube engaged with the first member via a first connector;
a second tube engaged with the second member via a second connector; and
wherein the first and second tubes are configured to receive the fastener.

11. The sign in accordance with claim 8, wherein the frame comprises:
a first member and a second member spaced a distance apart from one another;
a third member and a fourth member extending between and connected to first and second members;
an attachment extending between first and second members and configured to secure to display to the frame;
a first connector and a second connector extending outwardly from both the first and second members; and
wherein the first and second connectors on both the first and second members are configured to receive the fastener.

12. The sign in accordance with claim 8, wherein the fame comprises:
a first member and a second member spaced a distance apart from one another;
a pair of tines extending outwardly from the first and second members and configured to secure the display to the frame;
a first support extending outwardly from the first member and defining a first bore therethrough;
a second support extending outwardly from the second member and defining a second bore; and
wherein the first bore and the second bore are configured to receive the fastener.

13. The sign in accordance with claim 8, wherein the frame comprises:
a post configured to secure the display via a securement mechanism;
a receiver configured to receive and hold the post;
a set of supports extending outwardly from the receiver;
a set of bores extending through each of the set of supports; and
wherein each of the set of bores is configured to receive the fastener.

14. The sign according to claim 8, wherein the fastener comprises:
an enlarged head adapted to engage a tool;
a shaft extending outwardly from the enlarged head; and
wherein the threaded tip extends outwardly from the shaft.

15. A method of installing a sign comprising:
connecting a display with a frame;
engaging a fastener with the frame, wherein the fastener has a threaded tip;
engaging the threaded tip with the ground; and
rotating the fastener to penetrate the ground with the threaded tip while the frame remains stationary to thereby secure the frame to the ground.

16. The method according to claim 15, further comprising:
linearly translating the fastener along a vertical path of travel from a first position to a second position in response to rotating the fastener, wherein the vertical path of travel is located outside of a vertical plane defined by a vertical member of the frame.

17. The method according to claim 15, further comprising:
engaging a tool with an enlarged head of the fastener, wherein a shaft extends downward from the enlarged head and the threaded tip is integrally formed with the shaft;
powering the tool; and
penetrating the ground with the threaded tip via the tool and thereby securing the frame to the ground.

18. The method according to claim 16, further comprising:
securing the display to first and second members on the frame via an attachment.

19. The method according to claim 17, further comprising:
engaging a tube with both the first and second members of the frame; and
placing the shaft of the fastener within each of the tubes.

20. The method according to claim 17, further comprising:
engaging a first connector with the first member of the frame;
engaging a second with the second member of the frame; and
placing a shaft of the fastener within each of the first and second connectors.

21. The method according to claim 17, further comprising:
extending a first support outwardly from the first member of the frame;
extending a second support outwardly from the second member of the frame;
extending a bore through each of the first and second supports; and
receiving the shaft of the fastener within each of the first and second bores of the first and second supports.

22. The method according to claim 15, further comprising:
providing a post on the frame;
engaging the post with a receiver;
extending a support outwardly from the receiver;
extending a set of bores through the support; and
receiving a set of fasteners within the set of bores.
